(19) United States
(12) Patent Application Publication
(10) Pub. No.: US 2020/0027183 A1
(43) Pub. Date: Jan. 23, 2020

(54) NETWORK COMPUTER SYSTEM TO DETERMINE SUITABILITIES OF VEHICLES USING BLOCKCHAIN RECORDS

(71) Applicant: Uber Technologies, Inc., San Francisco, CA (US)

(72) Inventor: Euan Guttridge, Pittsburgh, PA (US)

(21) Appl. No.: 16/039,634

(22) Filed: Jul. 19, 2018

(51) Int. Cl. G06Q 50/30; G06F 17/30; H04L 9/06; H04L 9/08

(52) U.S. Cl. CPC G06Q 50/30; G06F 17/30991; H04L 9/0637; H04L 9/0861; G05D 2201/0213; G06F 17/30283; G06F 17/30144; H04L 2209/38; G06F 17/30185

(57) ABSTRACT

A network computer system can determine an identifier of a token that is uniquely associated with a vehicle. Additionally, the network computer system can utilize the identifier of the token to retrieve a record from a blockchain. Moreover, the network computer system can make a determination as to whether the vehicle is suitable for use with a network transport service based on the retrieved record.

### BACKGROUND

A network computer system can receive, from user devices, service requests for one or more network services. The service request can include data related to a service location (e.g., a service initialization location) that the service provider is to travel to, to provide the requested service. The network computer system can provide to the service provider routing information to the location. Increasingly, autonomous vehicles are also being used to provide transportation services.

### BRIEF DESCRIPTION OF THE DRAWINGS

FIG. 1 illustrates an example network computer system for determining a suitability of a vehicle for use with an on-demand network service;

FIG. 2 illustrates an example method to determine whether a vehicle is suitable for use for a network transport service;

FIG. 3A illustrates example user interfaces (UI) executing on a service application of a requester device to provide information related a vehicle that is selected to provide transport for a user;

FIG. 3B illustrates example user interfaces (UI) executing on a service application of a requester device that displays content from a record that is maintained with a blockchain service; and

FIG. 4 illustrates a computer system upon which aspects described herein may be implemented.

Throughout the drawings, identical reference numbers designate similar, but not necessarily identical elements. The figures are not necessarily to scale, and the size of some parts may be exaggerated to more clearly illustrate the example shown. Moreover, the drawings provide examples and/or implementations consistent with the description. However, the description is not limited to the examples and/or implementations provided in the drawings.

### DETAILED DESCRIPTION

In some examples, a network computer system determines whether a vehicle is suitable or use with a network transportation service (e.g., an on-demand transport service). In some examples, the determination of whether the vehicle is suitable is based on transactions that are recorded on an immutable ledger. In such examples, the immutable ledger can be provided with public blockchain services. In variations, the network computer system can write to the blockchain service a variety of records relating to the use or operability of the vehicle.

According to some examples, a vehicle is autonomous and owned by an owner entity that is independent of a network computer system that provides an on-demand transport service. In such examples, the network computer system can rely on, for example, inspections, certifications and/or service records that are signed by trusted entities on the blockchain service.

Among other benefits, examples enable requesters of an on-demand network transportation service or passengers of the vehicle to view the inspection records, certifications, or service history of the vehicle, as recorded by on the ledger of the blockchain service.

As provided herein, the terms “user,” “requester” and “service requester” are used throughout this application interchangeably to describe a person or group of people who utilize a requester application on a computing device to request, over one or more networks, on-demand services from a network computing system. The term “service provider” is used to describe a person utilizing a provider application on a computing device to provide on-demand services to the service requesters.

One or more examples described herein provide that methods, techniques, and actions performed by a computing device are performed programmatically, or as a computer-implemented method. Programmatically, as used, means through the use of code or computer-executable instructions. These instructions can be stored in one or more memory resources of the computing device. A programmatically performed step may or may not be automatic.

Additionally, one or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs, or machines.

Moreover, examples described herein can generally require the use of specialized computing devices, including processing and memory resources. For example, one or more examples described may be implemented, in whole or in part, on computing devices such as servers, desktop computers, cellular or smartphones, personal digital assistants (e.g., PDAs), laptop computers, printers, digital picture frames, network equipment (e.g., routers), wearable computing devices, and tablet devices. Memory, processing, and network resources may all be used in connection with the establishment, use, or performance of any example described herein (including with the performance of any method or with the implementation of any system). For instance, a computing device coupled to a data storage device storing the computer program and configured to execute the program corresponds to a special-purpose computing device. Furthermore, any computing systems referred to in the specification may include a single processor or may be architectures employing multiple processor designs for increased computing capability.

Furthermore, one or more examples described herein may be implemented through the use of instructions that are executable by one or more processors. These instructions may be carried on a computer-readable medium. Machines shown or described with figures below provide examples of processing resources and computer-readable mediums on which instructions for implementing examples described can be carried and/or executed. In particular, the numerous machines shown with examples described include processor(s) and various forms of memory for holding data and instructions. Examples of computer-readable mediums include permanent memory storage devices, such as hard drives on personal computers or servers. Other examples of computer storage mediums include portable storage units, such as CD or DVD units, flash memory (such as carried on smartphones, multifunctional devices or tablets), and magnetic memory. Computers, terminals, network enabled devices (e.g., mobile devices, such as cell phones) are all examples of machines and devices that utilize processors, memory, and instructions stored on computer-readable mediums. Additionally, examples may be implemented in the form of computer-programs, or a computer usable carrier medium capable of carrying such a program.

Alternatively, one or more examples described herein may be implemented through the use of dedicated hardware logic circuits that are comprised of an interconnection of logic gates. Such circuits are typically designed using a hardware description language (HDL), such as Verilog and VHDL. These languages contain instructions that ultimately define the layout of the circuit. However, once the circuit is fabricated, there are no instructions. All the processing is performed by interconnected gates.

### System Description

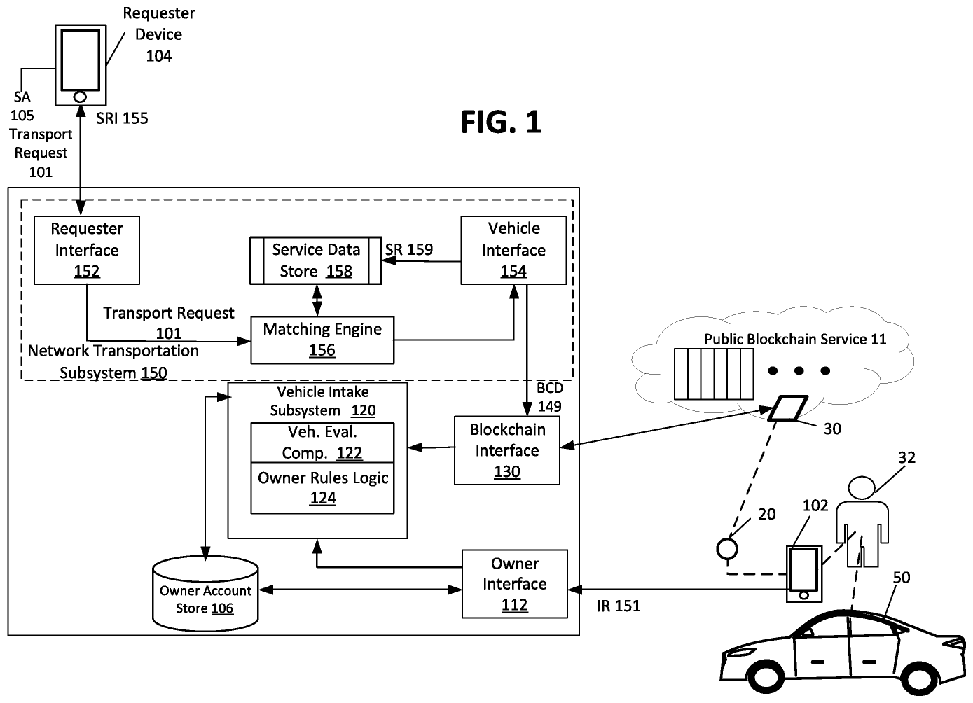

FIG. 1 illustrates an example network computer system for determining a suitability of a vehicle for use with an on-demand network service. In particular, network computer system 100 can determine a suitability of a vehicle (e.g., vehicle 50) for use with, for example, an on-demand network transportation service based on records contained in an immutable ledger of a blockchain service 11. As described by various examples, a vehicle can be deemed suitable for operation or use for a network transportation service if the vehicle is deemed safe. Additionally, the determination of suitability can consider rules, conditions and/or terms for the use of the vehicle, as specified by an owner entity, as well as the need for the vehicle by the network transportation service. In examples in which the vehicle is autonomous, the suitability of the vehicle can include a determination of whether the autonomous vehicle is sufficiently capable to navigate independently in a given geographic region.

According to examples, the network computer system 100 can utilize a blockchain service 11 which provides an immutable ledger to record transactions. The blockchain service 11 can maintain, for example, an immutable ledger that is maintained on a decentralized architecture.

In some examples, a vehicle 50 can be owned, or under control of an owner entity 32 (e.g., person, corporation, group of owners). By way of example, the owner entity 32 can have a lease, time-based ownership, or outright title to the vehicle 50. In some examples, the vehicle 50 is a fully autonomous vehicle, meaning the vehicle 50 can operate and travel routes to select destinations without a human driver.

According to some examples, the vehicle 50 can be assigned or otherwise associated to a blockchain token 20. In examples, the blockchain token 20 can include an encrypted alphanumeric string (e.g., private key) that can be stored in a data storage media of the owner entity 32. By way of example, the blockchain token 20 can be stored on a digital wallet of the user, which can reside on, for example, an owner device 102 of the owner entity 32, with a network account of the owner entity 32, or on a specialized storage device. In variations, the blockchain token 20 can be stored on a data storage media of the network computer system 100, or of a third-party.

In some examples, the owner entity 32 can elect to make the vehicle 50 available for use with an on-demand network transportation service that is implemented by the network computer system 100. In examples where the vehicle 50 is fully autonomous, the owner entity 32 can, for example, intermittingly make the vehicle 50 available to the on-demand network transportation service when the user is not utilizing the vehicle 50. As described by examples, the owner entity 32 can use transaction records, recorded in the blockchain ledger to provide verifiable records relating to the safety and capability of the vehicle 50.

The blockchain token 20 can be uniquely associated with addresses on the blockchain ledger of the blockchain service 11 which record transactions that identify the blockchain token 20. The blockchain token 20 can include a public identifier, such as a memory address, and the identifier can be used to read and/or write transactions to the blockchain ledger. In examples, transactions which are associated with the memory address or identifier of the blockchain token 20 are collectively referred to as a “token ledger” (represented in FIG. 1 by the “token ledger 30”). As with other portions of the blockchain ledger, the token ledger 30 can also be immutable.

In some examples, the token ledger 30 can store signed transactions that relate to the vehicle 50. In one implementation, the token ledger 30 can store a record that includes the vehicle identification number (VIN) or other unique identifier of the vehicle 50. The record can be created by, for example, the owner entity 32, using a signature that is generated from the blockchain token 20. In examples, once the VIN of the vehicle 50 is associated with the blockchain token 20 on the blockchain service 11, the VIN cannot be legitimately appropriated with another transaction unless there is a corresponding record that represents a corresponding transfer of the vehicle 50.

In examples, the owner entity 32 can have trusted third-parties sign transactions which are relevant to the vehicle 50 (e.g., service or inspection). By way of example, the token ledger 30 can include signed transactions, or records, of vehicle inspections, service checks, maintenance, and/or repairs, as performed by one or more pre-approved or trusted third-parties. The trusted third-parties can use their own blockchain token to sign transactions on the blockchain ledger, thereby creating a corresponding immutable record that is time stamped and associated with the vehicle 50. In implementations, the owner entity 32 can also sign the transactions using the blockchain token 20, to enable creation of a corresponding record on the blockchain service 11.

In examples, the network computer system 100 can include an owner interface 112, a vehicle intake subsystem 120, a blockchain interface 130 and a network transportation subsystem 150. The owner entity 32 can use the owner interface 112 to make the vehicle 50 available to the network transportation service for use as a transportation resource. The owner interface 112 can be implemented as, for example, a programmatic process that communicates with the owner device 102 of the owner entity 32. For example, the owner entity 32 can run a service application on the owner device 102 to register the vehicle 50 with the network transportation service provided through the network computer system 100. Registration by the owner entity 32 can generate an account that is stored with the owner account store 106. The account can include, or otherwise be associated with profile information which identifies information such as the vehicle 50 of the owner entity 32. As described below, the owner account store 106 can include a history of the usage of the vehicle 50 with the network computer system 100, including whether the vehicle 50 has previously been determined to be suitable for use by the system.

The owner device 102 can communicate an identifier of the owner entity 32 or the vehicle 50 to the network computer system 100. For example, the owner device 102 can transmit an identifier (e.g., mobile number, account identifier) to the owner interface 112, and the owner interface 112 can determine whether a vehicle or ledger address is associated with the account of owner entity 32 and/or owner device 102. In variations, the owner device 102 can transmit an identifier of the token ledger 30 to the owner interface 112.

Additionally, in some examples, the owner entity 32 can specify rules, conditions and/or terms for using the vehicle with the network transportation service. For example, the owner entity 32 of the vehicle 50 can make the vehicle available for a select number of hours during a time period when the owner is at work, or for a duration in which the vehicle 50 is on a trip and away from home. According to examples, the owner entity 32 can specify various rules and conditions relating to the use of the vehicle with the network transportation service of 100. For example, the owner entity 32 can specify available hours of vehicle use, the geographic range where the vehicle 50 can be used, and/or a maximum number of occupants that are to be included in the vehicle 50. The owner entity 32 can also specify one or more compensatory terms for the usage of vehicle 50. For example, the owner entity 32 can specify a time and/or distance based cost for use of the vehicle 50 by the network computer system 100. In some examples, the owner entity 32 can specify the rules, conditions, and/or compensatory terms through the service application of the owner device 102. As an addition or variation, the owner entity 32 or the network computer system 100 can communicate some or all of the rules, conditions, and/or compensatory terms to logic provided with a corresponding blockchain ledger. For example, the compensatory terms can be self-executed by logic provided through the blockchain ledger.

In examples, the owner entity 32 makes the vehicle 50 available for use by making a vehicle intake request 151 that is received by the owner interface 112. In response to receiving the owner interface 112, vehicle intake subsystem 120 implements one or more processes to determine whether to use the vehicle 50, in connection with the network transportation service, for a given time interval specified in the vehicle intake request 151.

In examples, vehicle intake subsystem 120 can include one or more processes which make determinations as to whether the network computer system 100 should use the vehicle 50 to arrange transport for requesters (e.g., riders). Vehicle intake subsystem 120 can make one or multiple determinations before accepting the vehicle 50 for use through the on-demand network transportation service. In examples, the determinations can include (i) a determination as to whether the vehicle 50 is suitable for the one-demand network transportation service, (ii) a determination as to whether there is an expectation of sufficient demand for the vehicle 50 during a time period in which the vehicle 50 is to be made available, and/or (iii) a determination as to whether rules, conditions and/or terms specified by the owner entity 32 with respect to the use of the vehicle 50 are acceptable.

According to examples, the vehicle intake subsystem 120 can include a vehicle evaluation component 122 to make a determination of the suitability of the vehicle 50 based on transaction records that reference the blockchain token 20 on the blockchain ledger. For example, the blockchain ledger can store transaction records that reference the public identifier of the blockchain token 20, and which reflect a purchase or age of the vehicle 50, service repairs, and/or recent inspections of the vehicle 50. The vehicle evaluation component 122 can access and read transaction records on the blockchain which reference the public identifier of the blockchain token 20 via blockchain interface 130. The blockchain records that reference the public identifier of the blockchain token 20 can be retrieved, and information contained in the records can be used to make the suitability determinations. By way of example, the records can include, for example, maintenance records, ownership records, and/or insurance records. The suitability determination made by the vehicle evaluation component 122 can be in the form of, for example, one or more scores, ratings and/or checklists. The vehicle evaluation component 122 can determine the suitability of the vehicle 50 by making, for example, a determination of an overall safety level of the vehicle 50. In examples in which the vehicle 50 is autonomous, the suitability determination can also relate to the capability of the vehicle 50 to operate autonomously. The determinations can further be specific as to whether the vehicle 50 is suitable for use in an on-demand network service.

In some variations, the determinations of the vehicle evaluation component 122 can also be written as a separate signed transaction with the blockchain service 11. Thus, for example, blockchain interface 130 can use a signature of network computer system 100 to create a transaction record that reflects one or more of the suitability determinations of the vehicle evaluation component 122 (e.g., safety score, autonomous capability), and the time and/or conditions when such determination(s) was made. In some implementations, the owner entity 32 may also sign the respective records as validation. For example, the owner entity 32 may be required to sign and validate transactions that are initiated by the system 100 as a condition for having the vehicle 50 used as part of the network transportation service.

In some examples, the network computer system 100 may implement requirements for inspection of the vehicle 50 before the vehicle 50 is accepted for use with the on-demand network transportation service. The inspection can be by, for example, a trusted third-party, to evaluate the operation of the vehicle 50 and/or the autonomous capability of the vehicle 50. The vehicle evaluation component 122 can use the public identifier of the blockchain token 20 to determine whether there is a signed record reflecting that a transaction in which the vehicle 50 was inspected by a trusted third-party.

Accordingly, the vehicle evaluation component 122 can access the blockchain ledger of the blockchain service 11 via the blockchain interface 130 to retrieve information about signed transactions relating to the operability, safety or capability (e.g., autonomous capability) of the vehicle 50. The vehicle evaluation component 122 can make the determination of suitability based on, for example, the type of inspections (or certifications) that were made on the vehicle 50, the source of the inspection or certification records, the recency of the inspections or certifications, and/or the result of the of the inspections or certifications. The vehicle evaluation component 122 can communicate the determination to the owner entity 32 via the owner interface 112. For example, the owner device 102 can generate a message that communicates to the owner entity 32 whether the system 100 has deemed the vehicle suitable. In some examples, the vehicle evaluation component 122 can communicate, via the owner interface 112, requirements of suitability to the owner interface 112 based on an outcome of the determination, or in advance of the making the determination. Thus, for example, if the vehicle 50 is deemed as not being suitable, the vehicle evaluation component 122 can communicate information as to what the owner entity 32 needs to do, such as identifying the type of inspection and/or a trusted source for providing the required inspection.

In other variations in which the vehicle 50 is autonomous, the vehicle 50 can be provided with software that can create records reflecting signed transactions of the vehicle 50, on blockchain ledger of the blockchain service 11. The autonomous capable vehicle 50 may, for example, create signed transaction records on the blockchain ledger to reflect the occurrence of events, such as the receipt of as map update or software version by the vehicle 50. In such variations, the vehicle evaluation component 122 can further make determinations of suitability based on information provided by such transaction records as stored in the blockchain ledger of the blockchain service 11.

Additionally, if the vehicle 50 is known (e.g., previously used by the network computer system 100), the network computer system 100 may still implement periodic requirements (e.g., based on passage of time, or miles driver) which mandate inspection or servicing of the vehicle 50 by a trusted source. In turn, the trusted source (e.g., third-party) can perform a required inspection and sign a transaction (which the owner entity 32 may cosign) with the blockchain ledger of the blockchain service 11, using a public identifier of the blockchain token 20. The signed record can identify, for example, the third-party, a data of the inspection, and the type of inspection that was performed.

In examples, the vehicle intake subsystem 120 can also evaluate other conditions or criteria before the vehicle 50 is used by the network computer system 100. The vehicle intake subsystem 120 can make a determination as to whether the network computer system 100 has need for the vehicle 50. For example, the determination can be based on existing or projected supply of vehicles, as well as existing or projected demand for transport by users of the network computer system 100. Thus, the vehicle intake subsystem 120 can make a determination as to whether to permit the vehicle 50 to become part of the available vehicles which the on-demand network transportation service can match to transport requests over a given time interval.

In examples, vehicle intake subsystem 120 can include owner rules logic 124 to evaluate the rules, conditions and/or terms that the owner entity 32 has specified in the blockchain with respect to the use of the vehicle 50. Vehicle intake subsystem 120 can implement the owner rules logic 124 to determine whether the network computer system 100 can meet, for example, rules and conditions relating to the use of the vehicle 50 (e.g., geographic region, time interval for vehicle use, restrictions with respect to number of passengers, etc.). Vehicle intake subsystem 120 can also implement the owner rules logic 124 to evaluate the terms of the use of the vehicle 50. Vehicle intake subsystem 120 can determine the rules, conditions and/or terms of the use of vehicle 50 from the blockchain ledger, using, for example, the public identifier of the blockchain token 20. Alternatively, vehicle intake subsystem 120 can determine some or all of the rules, conditions and/or terms of the use of vehicle 50 from the owner entity 32, via, for example, use of a service application running on the owner device 102.

According to examples, vehicle intake subsystem 120 can determine that the terms specified by the owner entity 32 are too expensive, given the current projection of available vehicles and demand for the specified time interval. In some examples, the owner rules logic 124 can be implemented to evaluate and determine the rules, conditions and terms of the owner as satisfactory or not satisfactory. Vehicle intake subsystem 120 can communicate the outcome to the owner entity 32 via the owner interface 112. In some variations, if the determination is not satisfactory, the owner entity 32 can make a change (e.g., reduce cost or relax condition) to have the evaluation of the rules, conditions and/or terms be satisfactory.

If, in response to the vehicle intake request (IR) 151, vehicle intake subsystem 120 determines to use the vehicle 50, vehicle intake subsystem 120 can make the vehicle 50 available to the network transportation subsystem 150. The network transportation subsystem 150 can include a requester interface 152, a vehicle interface 154, a matching engine 156, and a service data store 158. In examples in which the vehicle 50 is an autonomous vehicle that is to be used to provide transport, the vehicle interface 154 can establish a communication link with the vehicle 50 (e.g., using information provided by the owner entity 32). The vehicle interface 154 can identify, for example, a location of the vehicle 50 using location-aware resources of the vehicle 50 (e.g., satellite receiver). The vehicle interface 154 can further create and/or update a service record (SR) 159 for the vehicle 50 with the service data store 158, where the service record identifies a current location of the vehicle 50, as well as other information, such as a state of the vehicle 50 (e.g., open), and/or a type of the vehicle 50 (e.g., full autonomous). In some variations, the vehicle interface 154 can also instruct, or otherwise control the vehicle 50 to position itself at a particular sub-region, in order to better the vehicle's ability to meet projected demand, and/or to improve the performance of vehicle 50 (e.g., position vehicle in well-mapped region). As the vehicle 50 travels, the vehicle interface 154 can track the vehicle 50 and update the record of the vehicle 50 with the service data store 158 as to the current location of the vehicle 50.

With further reference to the network transportation subsystem 150, the requester interface 152 can communicate with requester devices 104 of a population of users (as represented by requester device 104 in FIG. 1). The requester device 104 can, for example, implement a corresponding service application (SA) 105, which individual requesters can use to make transport requests 101. The transport requests 101 can specify parameters such as a service start location (e.g., pickup location), destination location (e.g., drop-off location), and other parameters such as the type of vehicle which the requester prefers or requires. In examples in which autonomous vehicles are available for requesters, the requester can specify a preference for or against an autonomous vehicle. Additionally, the requester can specify a preference for or against autonomous vehicles of different sources (e.g., privately owned, provided by particular entity, etc.). The requester interface 152 can receive the transport request 101 from the requester device 104, and the matching engine 156 can match the transport request 101 to an available vehicle (e.g., vehicle 50) based on the service parameters (e.g., start location, destination location, type of vehicle) of the request.

When the matching engine 156 selects the vehicle 50 for a given transport request 101, the matching engine 156 can communicate information about the matched service request to the vehicle interface 154. For example, the information can identify the service start and destination locations. In turn, the vehicle interface 154 can instruct the vehicle 50 to travel to the service start location to meet the passengers or requesters. In some variations, the vehicle interface 154 can also communicate instructions for additional operations to facilitate the transport service provided by the vehicle 50. For example, the vehicle interface 154 can communicate a stopping location, where the vehicle 50 can stop temporarily to meet the passenger. In some variations, the vehicle interface 154 can communicate with the requester interface 152 to determine, for example, when the passenger enters the vehicle 50. For example, the requester interface 152 may have the rider signal in response to when the passenger is seated, at which time, the vehicle interface 154 instructs the vehicle 50 to travel to the destination of the given transport request 101.

With respect to autonomous vehicles, examples recognize that passengers or requesters may want assurance of a safety or capability of vehicle 50 before accepting to ride in the vehicle 50, particularly if the vehicle 50 is an autonomous vehicle being supplied by an individual or unknown third-party. In such examples, the network computer system 100 may arrange transport using autonomous vehicles from multiple sources, including vehicles that are its own, as well as vehicles that belong to third-parties such as the owner entity 32. For example, in cases such as described, the requester interface 152 can provide safety-related information 155, based directly or indirectly off the token ledger 30 of the vehicle 50. The safety-related information 155 can be provided automatically, or in response to a request from the rider. To provide the safety-related information 155, the requester interface 152 can retrieve a copy of the most recent inspection and/or certification records of vehicle 50. In some implementations, the retrieved records may be retrieved through the blockchain interface 130, using the public identifier of the blockchain token 20. In some variations, the vehicle intake subsystem 120 can retrieve a recent copy of the records of vehicle 50 from the owner account store 106, rather than from the blockchain ledger of the blockchain service 11.

As an addition or variation, the requester interface 152 can retrieve, from the owner account store 106, a link to one or more specific transactions on the blockchain ledger of the blockchain service 11, corresponding to inspection, certification and/or service records of the vehicle 50. The requester interface 152 can provide the requester device 104 with the link to directly access the relevant records of the vehicle 50, as maintained by the blockchain ledger of the blockchain service 11. In some variations, the link can be a direct or link to a specific record of the blockchain ledger of the blockchain service 11. In some examples, the requester interface 152 can provide content to the requester device 104, based on retrieved transaction records from the blockchain ledger of the blockchain service 11, and/or the determinations of vehicle intake subsystem 120 (e.g., a determined safety score of the vehicle 50).

In examples, the vehicle interface 154 can implement monitoring operations on the vehicle 50, to track, for example, a location and/or route of the vehicle 50, as well as to identify events of varying magnitude. For example, the vehicle interface 154 can monitor the vehicle 50 to detect events such as accidents, near-accidents, incidents of suspect driving (e.g., overly sharp turn or braking event), indicators of vehicle damage, or other events. The vehicle interface 154 can record one or more transactions with the blockchain ledger of the blockchain service 11, via blockchain interface 130, using the public identifier of the blockchain token 20. In examples, the owner entity 32 of the vehicle 50 may also sign the signed transactions generated by the network computer system 100 (e.g., as a requirement to have the vehicle 50 used with the network transportation service). The recorded transactions of the vehicle interface 154 can include information that is based on information determined from monitoring the vehicle 50. Depending on implementation, the vehicle interface 154 can generate blockchain data (BCD) 149, for block chain records 161, via blockchain interface 130, to include information such as, for example, (i) the occurrence of safety-related events, such as an accident involving the vehicle 50, (ii) the occurrence of potential safety issues or hazards, such as close-calls, encounters with road debris, etc., and/or (iii) usage information (e.g., the distance traveled in the vehicle 50 with other riders).

In some variations, the vehicle interface 154 can detect thresholds or events after which the vehicle 50 should be serviced, inspected and certified. The vehicle interface 154 can record such events with the owner account store 106, such that on one or more following instances (e.g., when the owner entity 32 makes another vehicle intake request 151), the owner interface 112 can use profile information stored with the owner account store 106 to request the owner entity 32 to service, inspect and/or certify the vehicle 50. As an addition or variation, the vehicle interface 154 can record with the token ledger 30, via blockchain interface 130, the request for the owner entity 32 to service, inspect and/or certify the vehicle 50.

In some variations, the vehicle interface 154 can determine usage information as the vehicle 50 is used with the network computer system 100. Blockchain interface 130 can further generate records with the token ledger 30 that reflect the usage information. By way of example, the usage information can reflect periodic odometer readings, records of individual transport requests that were fulfilled using the vehicle 50 (e.g., service start location, destination location, number of riders, etc.) and/or the number of tolls which the vehicle 50 passed through or incurred payment of. In such examples, the owner entity 32 can use the log information to determine a usage level of the vehicle 50.

In other examples, the requester interface 152 can provide a rating interface to the requester device 104, via the service application 105. A passenger of the vehicle 50 can record a rating feedback, which can be received by the requester interface 152 and recorded against the blockchain ledger of the blockchain service 11.

Still further, in order examples, the vehicle interface 154 detects and records, via blockchain interface 130, sensor information of the vehicle 50, on a periodic basis. By way of example, such records can include periodic determination of location information of the vehicle 50, and/or vehicle information of vehicle 50 (e.g., onboard diagnostic data or “OBD”).

### Methodology

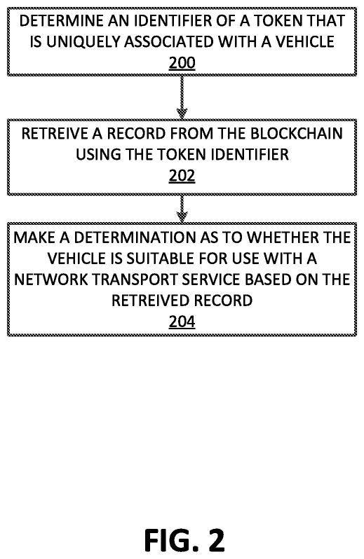

FIG. 2 illustrates an example method to determine whether a vehicle is suitable for use for a network transport service. In the below discussions of FIG. 2, reference may be made to reference characters representing features a shown and described with respect to FIG. 1 for purpose of illustrating a suitable component for performing a set or sub-step being described.

With reference to FIG. 2, the network computer system 100 can determine an identifier of a token that is uniquely associated with a vehicle (e.g., vehicle 50) (200). For example, the network computer system 100 can identify the blockchain token 20 in response to an owner entity 32 making a vehicle intake request (VR) 151. For example, in the context of autonomous vehicles, an owner entity 32 can make the vehicle 50 available for use with a network transport service when the autonomous capable vehicle 50 is not in use. As described with an example of FIG. 1, the vehicle intake subsystem 120 can determine a public identifier of blockchain token 20. In examples, the owner entity 32 can associate the vehicle 50 with the blockchain token 20, by, for example, creating a transaction record that specifies the vehicle identification number (VIN) of the vehicle 50 using the blockchain token 20.

Network computer system 100 can retrieve a record from a blockchain using the token identifier (202). For example, vehicle intake subsystem 120 can access and read transaction records on the blockchain which reference the public identifier of blockchain token 20 via blockchain interface 130. The blockchain records that reference the public identifier of the blockchain token 20 can be retrieved by, for example, the blockchain interface 130, using the public identifier of the blockchain token 20. By way of example, the retrieved records can include, for example, maintenance records, ownership records, and/or insurance records. The records can be self-verified when signed by trusted third-parties.

Network computer system 100 can make a determination as to whether the vehicle is suitable for use with a network transport service based on one or more retrieved records from the blockchain ledger of the blockchain service 11 (204). For example, the vehicle intake subsystem 120 can make a determination of the suitability of vehicle 50, based on the retrieved records. The received records can reference the public identifier of the blockchain token 20 on the blockchain ledger of the blockchain service 11. The vehicle intake subsystem 120 can determine the suitability of the vehicle 50 by making, for example, a determination of an overall safety level of the vehicle 50. In examples in which the vehicle 50 is autonomous, the suitability determination can also relate to the capability of the vehicle 50 to operate autonomously. The determinations can further be specific as to whether the vehicle 50 is suitable for use in an on-demand network service. In examples, the suitability determination made by the vehicle intake subsystem 120 can be in the form of, for example, one or more scores, ratings and/or checklists.

### User Interface

In scenarios provided for by examples, a user of requester device 104 makes a transport request of the network computer system 100, and the network computer system 100 selects an autonomous vehicle (e.g., vehicle 50 that has autonomous capabilities) for the user. Examples recognize that the user may want assurance that the arriving autonomous vehicle is safe to ride and is capable of autonomous driving to a destination specified by the transport request.

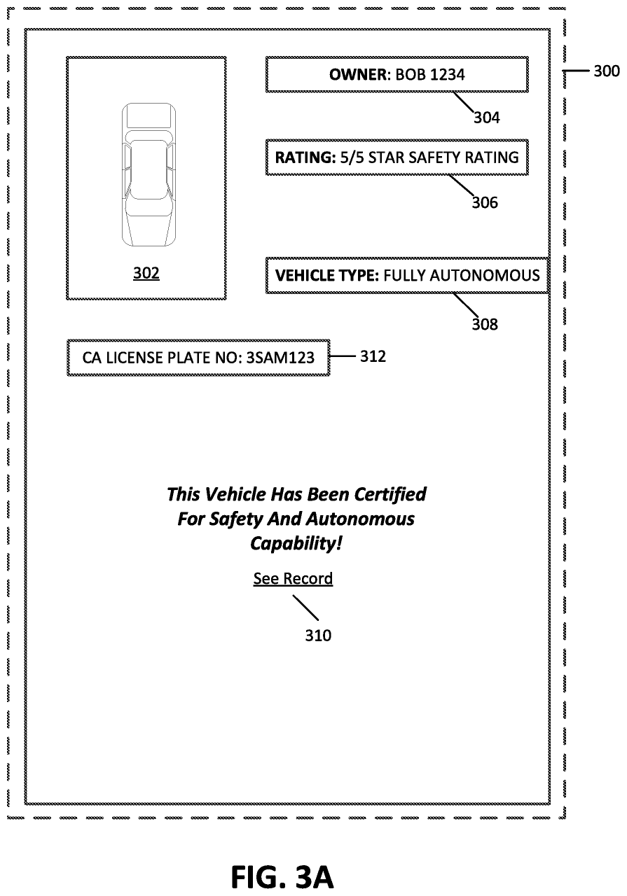

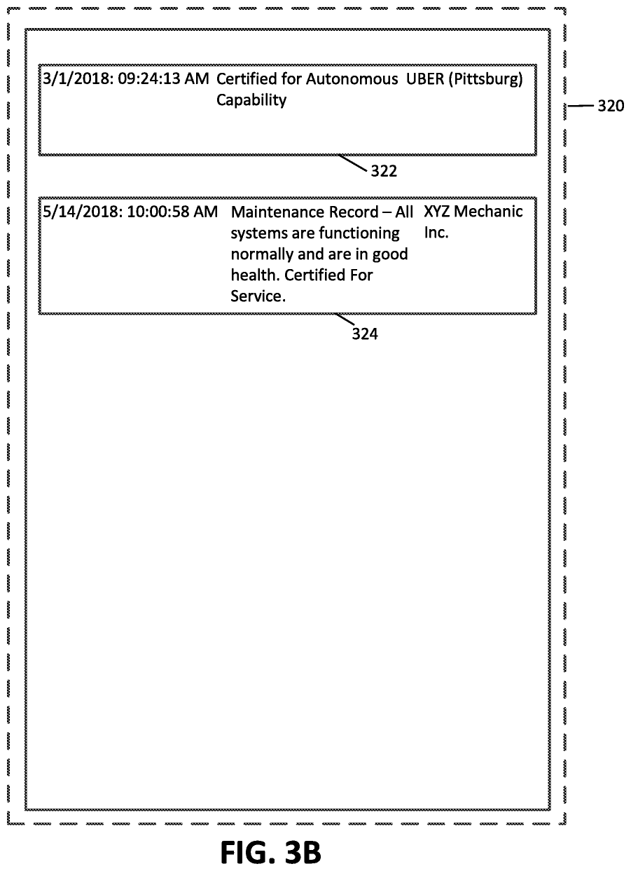

FIG. 3A illustrates an example user interface (UI) executing on a service application of a requester device to provide information related to a vehicle that is selected to provide transport for a user. For example, FIG. 3A includes user interface 300 that be provided by a service application (e.g., service application 105) running on a requester device (e.g., requester device 104). User interface 300 can include various information panels, such as a photograph panel 302 that depicts a picture of the assigned vehicle, as well as a name (e.g., first name) or other identifiers 304 of the owner entity 32, and one or more visible vehicle identifiers 312 (e.g., license plate number, color, make, model) of the assigned vehicle.

User interface 300 can also include panels that can provide information relevant to the safety and/or capability of the assigned vehicle. For example, the user interface 300 can include safety rating panel 306. Safety rating panel 306 can include safety related information (e.g., safety-related information 155) that is based directly or indirectly a record that references the public identifier of the blockchain token 20, on the blockchain ledger of the blockchain service 11. By way of example, the record can directly or indirectly identify a most recent inspection, certification, or maintenance record of the vehicle. Additionally, the user interface 300 can include vehicle type panel 308. Vehicle type panel 308 can include vehicle capability related information (e.g., autonomous driving capabilities of the vehicle assigned to the service request). Vehicle capability related information can also be based directly or indirectly from a record (e.g., autonomous capability certification) that references the public identifier of the blockchain token 20, on the blockchain ledger of the blockchain service 11.

FIG. 3B illustrates an example user interface (UI) executing on a service application of a requester device that displays content from a record that is maintained with a blockchain service (e.g., blockchain service 11). In particular, some examples provide for the user interface 300 to include a selectable feature 310 that enables requester to directly view a safety-related record that is stored with the blockchain ledger of the blockchain. As illustrated in FIG. 3B, selection of selectable feature 310 can cause a service application of a requester device to present the record (or records) that the safety rating panel 306 is based on. As illustrated by FIG. 3B, user interface 320 can be displayed in response to a user selecting the selectable feature 310, as shown in an example of FIG. 3A.

In examples, the user interface 320 can display content corresponding to records 322, 324. Record 322 can display the contents of a record maintained with the blockchain service 11, and referencing the public identifier of the blockchain token 20, where the displayed record relates to a certification of the autonomous capability of the vehicle, by a trusted source. Similarly, the record 324 can display the contents of a record maintained with the blockchain service 11, which references the public identifier of the blockchain token 20, where the record reflects a safety-related inspection by a trusted third-party.

### Hardware Diagram

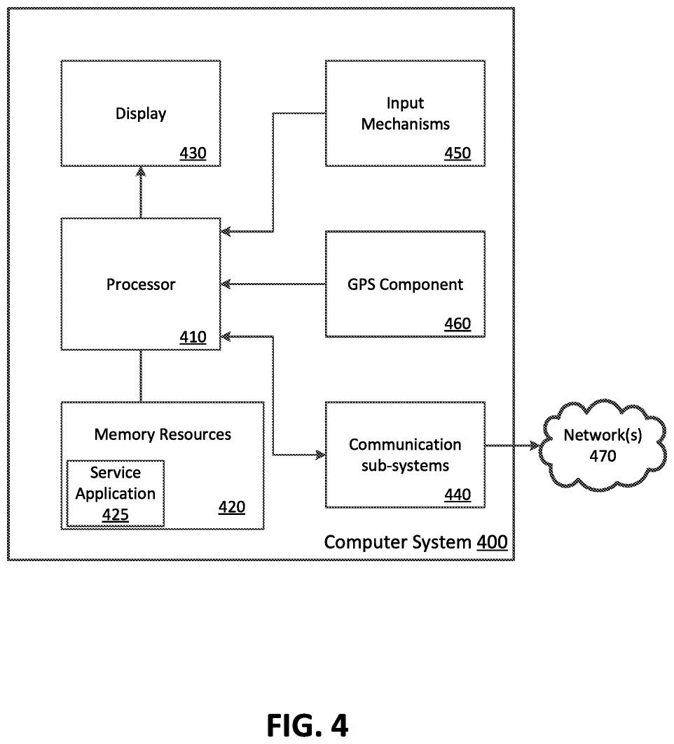

FIG. 4 is a block diagram that illustrates a computer system upon which examples described herein may be implemented. In one embodiment, computer system 400 may correspond to a mobile computing device, such as a cellular device that is capable of telephony, messaging, and data services. Computer system 400 can correspond to a device operated by a requester or, in some examples, a device operated by the service provider (e.g., a freight operator) that provides location-based services. Examples of such devices include smartphones, handsets, tablet devices, or in-vehicle computing devices that communicate with cellular carriers. Computer system 400 includes processor 410, memory resources 420, display component 430 (e.g., such as a touch-sensitive display device), one or more communication sub-systems 440 (including wireless communication systems), one or more input mechanisms 450 (e.g., accelerometer and/or gyroscope, microphone, barometer, etc.), and one or more location detection components (e.g., GPS component) 460. In one example, at least one communication sub-system 440 sends and receives cellular data over network(s) 470 (e.g., data channels and voice channels). Communication sub-systems 440 can include a cellular transceiver and one or more short-range wireless transceivers. Processor 410 can exchange data with a service arrangement system (not illustrated in FIG. 4) via the one or more communications sub-systems 440 and over network(s) 470.

Processor 410 can provide a variety of content to display component 430 by executing instructions stored in memory resources 420. Memory resources 420 can store instructions for service application 425. For example, processor 410 can execute the service application 425 to read data from one or more input mechanisms 450 of the computing device, and to transmit the data, along with location data of GPS component 460 as local device data to a network computer system (e.g. network computer system 100).

Examples described herein to extend to individual elements and concepts described herein, independently of other concepts, ideas or system, as well as for examples to include combinations of elements recited anywhere in this application. Although examples are described in detail herein with reference to the accompanying drawings, it is to be understood that the concepts are not limited to those precise examples. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mentioned of the particular feature. Thus, the absence of describing combinations should not preclude having rights to such combinations.

What is claimed is:

1. A network computer system comprising:
one or more processors;
a set of memory resources to store a set of instructions, the one or more processors executing the set of instructions to:
determine an identifier of a token that is uniquely associated with a vehicle;
retrieve a record from a blockchain using the identifier of the token; and
make a determination as to whether the vehicle is suitable for use with a network transport service based on the retrieved record.

2. The network computer system of claim 1, wherein the one or more processors execute the set of instructions to further:
determine, from the retrieved record, a rule, condition or term for use of the vehicle by the network transport service.

3. The network computer system of claim 1, wherein the retrieved record identifies a maintenance record, and wherein the determination is based at least in part on the maintenance record.

4. The network computer system of claim 1, wherein the retrieved record identifies an ownership record, and wherein the determination is based at least in part on the ownership record.

5. The network computer system of claim 1, wherein the retrieved record identifies an inspection or certification record of the vehicle, and wherein the determination is based at least in part on the inspection or certification record.

6. The network computer system of claim 1, wherein the determination is based at least in part on a party that signed the retrieved record.

7. The network computer system of claim 1, wherein the one or more processors execute the set of instructions to further:
monitor use of the vehicle in connection with the network transport service; and
record a transaction against the vehicle using the identifier, the recorded transaction including information determined from monitoring use of the vehicle with the network transport service.

8. The network computer system of claim 7, wherein the one or more processors detect a safety event by monitoring use of the vehicle, and wherein the information that is included with the recorded transaction includes information about the detected safety event.

9. The network computer system of claim 8, wherein the detected safety event includes one of an accident involving the vehicle, the vehicle having a near accident, or the vehicle having a malfunction.

10. The network computer system of claim 1, wherein the one or more processors execute the instructions to further:
record a transaction against the vehicle to identify individual transport requests which the vehicle fulfilled.

11. The network computer system of claim 10, wherein the one or more processors execute the set of instructions to further:
display, on a computing device of a current or future passenger of the vehicle, information about a safety level of the vehicle, the information being determined from the retrieved record.

12. The network computer system of claim 11, wherein the one or more processors execute the set of instructions to further:
display a direct link to the retrieved record at the blockchain on the computing device of the current or future passenger.

13. The network computer system of claim 1, wherein the determined identifier identifies a transaction that includes, or is based on a vehicle identification number.

14. The network computer system of claim 13, wherein the retrieved record identifies the vehicle.

15. The network computer system of claim 1, wherein the one or more processors execute the set of instructions to further:
display, on a computing device of a current or prior passenger of the vehicle, a rating interface to rate a quality of a transport associated with the vehicle.

16. The network computer system of claim 15, wherein the one or more processors execute the set of instructions to further:
create a record on the blockchain of a rating feedback that the current or prior passenger provided relating to the quality of the transport that passenger received within the vehicle.

17. The network computer system of claim 1, wherein the vehicle is a fully autonomous vehicle.

18. The network computer system of claim 1, wherein the one or more processors make the determination as to whether the vehicle is suitable in response to receiving a vehicle intake request from an owner entity of the vehicle.

19. A non-transitory computer readable medium that stores instructions, which when executed by one or more processors of a network computer system, cause the network computer system to perform operations that include:
determining an identifier of a token that is uniquely associated with a vehicle;
retrieving a record from a blockchain using the identifier of the token; and
making a determination as to whether the vehicle is suitable for use with a network transport service based on the retrieved record.

20. A method for operating a network transportation service, the method being implemented by one or more processors and comprising:
determining an identifier of a token that is uniquely associated with a vehicle;
retrieving a record from a blockchain using the identifier of the token; and
making a determination as to whether the vehicle is suitable for use with a network transport service based on the retrieved record.
